(19) United States
(12) Patent Application Publication
(10) Pub. No.: US 2014/0062265 A1
(43) Pub. Date: Mar. 6, 2014

(54) BRUSHLESS DC MOTOR

(71) Applicants: HUBEI QUEEN-OCEAN ELECTRICAL APPLIANCE MANUFACTURE CO., LTD., (US); ZHONGSHAN BROAD-OCEAN MOTOR CO., LTD, Zhongshan (CN)

(72) Inventors: Chongsheng ZENG, Zhongshan (CN); Songfa TANG, Zhongshan (CN)

(73) Assignees: HUBEI QUEEN-OCEAN ELECTRICAL APPLIANCE MANUFACTURE CO., LTD., Xiaogan (CN); ZHONGSHAN BROAD-OCEAN MOTOR CO., LTD., Zhongshan (CN)

(21) Appl. No.: 13/844,962

(22) Filed: Mar. 16, 2013

(30) Foreign Application Priority Data
Aug. 31, 2012 (CN) 201220445074.2

(51) Int. Cl. H02K 5/04; H02K 9/22; H02K 11/00

(52) U.S. Cl. CPC H02K 5/04; H02K 11/0068; H02K 9/22
USPC 310/60 R; 310/91; 310/52

(57) ABSTRACT

A brushless DC motor, including: a motor body; a damping ring; a mounting bracket; a locking device; and a controller. The controller includes: a control box, and a circuit board. Two sides of the mounting bracket are convex upward to form two supporting plates, respectively. Each supporting plate is provided with a recess. The damping ring is disposed on each end of the motor body. A bottom of the damping ring matches with the recess of the mounting bracket. The damping ring is fixed on the mounting bracket by the locking device. The circuit board is arranged inside the control box. The control box is disposed on the motor body.

### CROSS-REFERENCE TO RELATED APPLICATIONS

Pursuant to 35 U.S.C. §119 and the Paris Convention Treaty, this application claims the benefit of Chinese Patent Application No. 201220445074.2 filed Aug. 31, 2012, the contents of which are incorporated herein by reference. Inquiries from the public to applicants or assignees concerning this document or the related applications should be directed to: Matthias Scholl P.C., Attn.: Dr. Matthias Scholl Esq., 14781 Memorial Drive, Suite 1319, Houston, Tex. 77079.

### BACKGROUND OF THE INVENTION

1. Field of the Invention

The invention relates to a brushless DC motor.

2. Description of the Related Art

A typical motor structure for installing a coil fan includes: a motor body, a damping ring, a mounting bracket, and a locking device. Each side of the mounting bracket is convex upward to form a supporting plate including a recess. The damping ring is arranged on each end of the motor body. A bottom of the damping ring is embedded in the recess of the mounting bracket. The damping ring is fastened on the mounting bracket by the locking device. However, the controller for controlling the motor is arranged outside and separated from the motor. The controller is connected to the motor via a lead wire. The structure has the following defects: 1) the external controller is easy to be interfered, which affects a normal operation of the motor; 2) connected by the lead, the wiring and installation are difficult; and 3) the structure has a large volume, thereby occupying a large space.

### SUMMARY OF THE INVENTION

In view of the above-described problems, it is one objective of the invention to provide a brushless DC motor that has a simple and compact structure, small volume, simple and easy installation, and little external interference.

To achieve the above objective, in accordance with one embodiment of the invention, there is provided a brushless DC motor comprising: a motor body, a damping ring, a mounting bracket, and a locking device. Two sides of the mounting bracket are convex upward to form two supporting plates, respectively; each supporting plate is provided with a recess. The damping ring is disposed on each end of the motor body; and a bottom of the damping ring matches with the recess of the mounting bracket. The damping ring is fixed on the mounting bracket by the locking device. The brushless DC motor of the invention further comprises a controller. The controller comprises: a control box, and a circuit board. The circuit board is arranged inside the control box, and the control box is disposed on the motor body.

In a class of this embodiment, the motor body comprises: a shaft, a rotor assembly, a stator assembly, a housing, a front end cover, and a rear end cover. The shaft and the rotor assembly are connected together. The rotor assembly is nested inside the stator assembly. The housing and the stator assembly are connected together. The front end cover and the rear end cover are disposed on two ends of the housing, respectively. The shaft is disposed on a bearing of the front end cover and a bearing of the rear end cover. The control box is disposed on the rear end cover.

In a class of this embodiment, the locking device comprises: a left clasp, and a right clasp. Both the two clasps comprise two ends. One end of the left clasp and one end of the right clasp are connected to the supporting plate; and the other end of left clasp and the other end of the right clasp are connected together by a screw bolt and a nut for fastening a top of the damping ring.

In a class of this embodiment, a top of the control box is provided with an opening. A plurality of notches is arranged on a top surface of a side wall of the control box outside the opening. The notch is embedded into the supporting plate. A convex plate is arranged between two adjacent notches. A through hole is disposed on a middle part of the supporting plate. The convex plate is embedded in the through hole and is disposed on the rear end cover

In a class of this embodiment, the circuit board is arranged at a bottom of the control box. An IGBT module is disposed on the circuit board. The bottom of the control box is convex to form a heat dissipation boss. The IGBT module attaches to a top surface of the heat dissipation boss. The IGBT module is pressed by a press plate and fastened on the heat dissipation boss by a screw.

In a class of this embodiment, the rotor assembly comprises: a rotor core, a magnetic ring bracket, and a magnetic ring. The magnetic ring is embedded in the magnetic ring bracket. The magnetic ring bracket and the rotor core are integrated as a whole body by injection molding. A plurality of fan blades is disposed outside the magnetic ring on an end surface of the magnetic ring bracket.

In a class of this embodiment, a plurality of fan blades is evenly distributed on two end surfaces of the magnetic ring bracket.

In a class of this embodiment, a Hall plate is disposed on a bottom of the rear end cover above the magnetic ring bracket. A Hall element is arranged on the Hall plate outside the magnetic ring.

In a class of this embodiment, a locking bracket is disposed between the left clasp and the right clasp. The locking bracket is connected with the left clasp and the right clasp via the screw bolt and nut and is disposed on the top of the damping ring.

In a class of this embodiment, a plurality of heat dissipation ribs is arranged on an outer surface of the control box.

In a class of this embodiment, the control box is arranged on the rear end cover. The damping ring arranged on the rear end cover is disposed inside the control box.

Advantages of the invention are summarized as follows:
1) The controller is directly disposed on the motor body, thus, the invention is advantageous in the simple and compact structure, small volume, simple and easy installation, and little external interference.
2) The locking device comprises: the left clasp, and the right clasp. Both the two clasps comprise two ends. One end of the left clasp and one end of the right clasp are connected to the supporting plate; and the other end of left clasp and the other end of the right clasp are connected together by the screw bolt and the nut for fastening the top of the damping ring. The structure is reasonably designed, and the connection is firm.
3) The top of the control box is provided with the opening. A plurality of notches is arranged on the top surface of the side wall of the control box outside the opening. The notch is embedded into the supporting plate. The convex plate is arranged between two adjacent notches. The first through hole is disposed on the middle part of the supporting plate. The convex plate is embedded in the first through hole and is disposed on the rear end cover. The convex plate broadens the contacting area between the control box and the rear end cover to make the connection of the control box firm and not easy to shake.
4) The IGBT module is disposed on the circuit board. The bottom of the control box is convex to form the heat dissipation boss. The IGBT module attaches to the top surface of the heat dissipation boss. The IGBT module is pressed by the press plate and fastened on the heat dissipation boss by the screw. Thus, the effect of the heat dissipation is good.
5) The rotor assembly comprises: the rotor core, the magnetic ring bracket, and the magnetic ring. The magnetic ring is embedded in the magnetic ring bracket. The magnetic ring bracket and the rotor core are integrated as the whole body by injection molding. A plurality of fan blades is disposed outside the magnetic ring on the end surface of the magnetic ring bracket. The fan blades rotate to circulate the air for cooling the motor.
6) The Hall plate is disposed on the bottom of the rear end cover above the magnetic ring bracket. The Hall element is arranged on the Hall plate outside the magnetic ring. The Hall element measures the rotating position of the rotor, and the measurement has a high accuracy.
7) The locking bracket is disposed between the left clasp and the right clasp. The locking bracket is connected with the left clasp and the right clasp via the screw bolt and nut and is disposed on the top of the damping ring. Two sides of the motor are fastened into a whole body through tension by the locking bracket, which keeps the mounting bracket from extension or deformation in using.
8) The plurality of heat dissipation ribs are arranged on the outer surface of the control box to increase the heat dissipation area of the controller and realize a good heat dissipation effect.

### BRIEF DESCRIPTION OF THE DRAWINGS

FIG. 1 is a stereogram of a brushless DC motor in accordance with one embodiment of the invention;

FIG. 2 is an exploded view of a brushless DC motor in accordance with one embodiment of the invention;

FIG. 3 is a structure diagram of a brushless DC motor in accordance with one embodiment of the invention;

FIG. 4 is a cross sectional view taken from line A-A of FIG. 3;

FIG. 5 is an enlarged view of part C-C of FIG. 4;

FIG. 6 is a cross sectional view taken from line B-B of FIG. 3;

FIG. 7 is an enlarged view of part D-D of FIG. 6; and

FIG. 8 is a stereogram of a motor rotor in accordance with one embodiment of the invention.

### DETAILED DESCRIPTION OF THE EMBODIMENTS

For further illustrating the invention, experiments detailing a brushless DC motor are described below. It should be noted that the following examples are intended to describe and not to limit the invention.

### Example 1

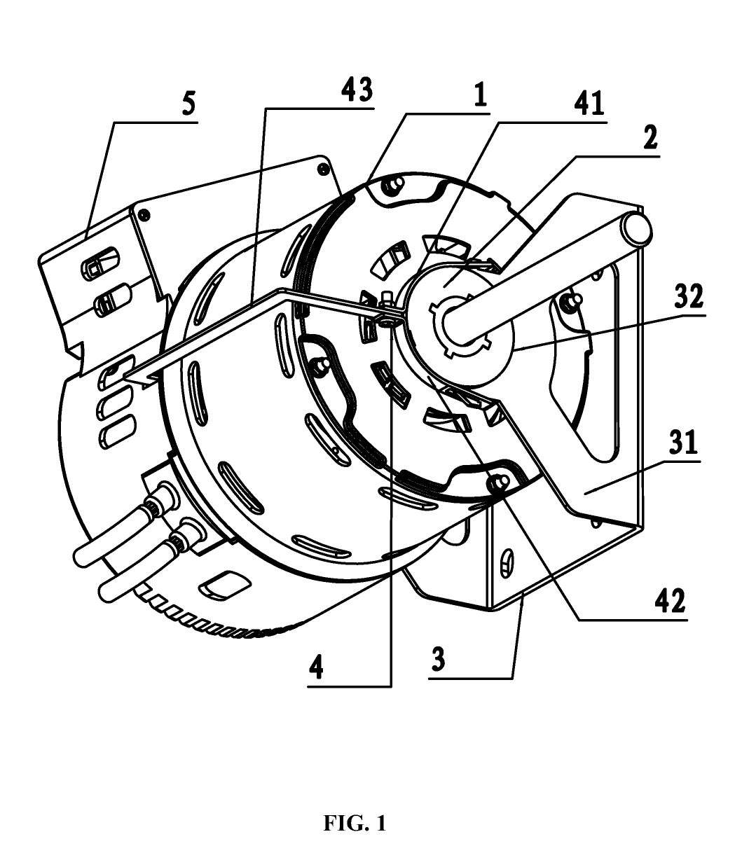

As shown in FIGS. 1-8, a brushless DC motor comprises: a motor body 1, a damping ring 2, a mounting bracket 3, and a locking device 4. Two sides of the mounting bracket 3 are convex upward to form two supporting plates 31, respectively; each supporting plate 31 is provided with a recess 32. The damping ring 2 is disposed on each end of the motor body 1; and a bottom of the damping ring 2 matches with the recess 32 of the mounting bracket 3. The damping ring 2 is fixed on the mounting bracket 3 by the locking device 4. The brushless DC motor further comprises a controller 5. The controller 5 comprises: a control box 51, and a circuit board 52. The circuit board 52 is arranged inside the control box 51, and the control box 51 is disposed on the motor body 1.

### Example 2

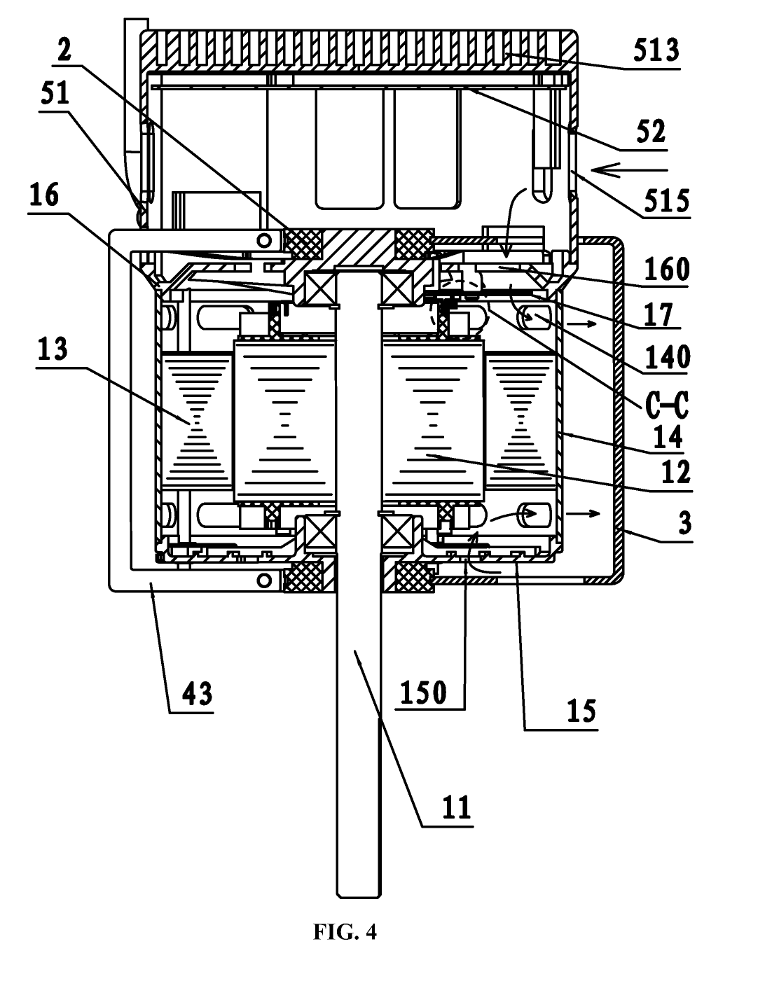

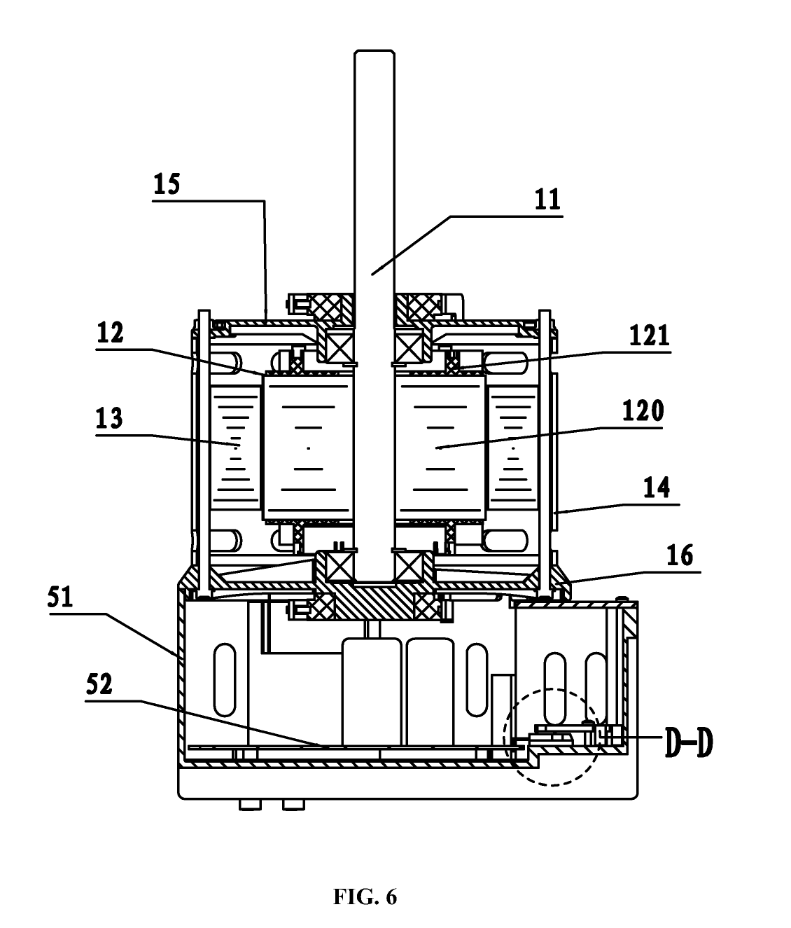

As shown in FIG. 4 and FIG. 6, based on Example 1, the following technical features are added: the motor body 1 comprises: a shaft 11, a rotor assembly 12, a stator assembly 13, a housing 14, a front end cover 15, and a rear end cover 16. The shaft 11 and the rotor assembly 12 are connected together. The rotor assembly 12 is nested inside the stator assembly 13. The housing 14 and the stator assembly 13 are connected together. The front end cover 15 and the rear end cover 16 are disposed on two ends of the housing 14, respectively. The shaft 11 is disposed on a bearing of the front end cover 15 and a bearing of the rear end cover 16. The control box 51 is disposed on the rear end cover 16.

### Example 3

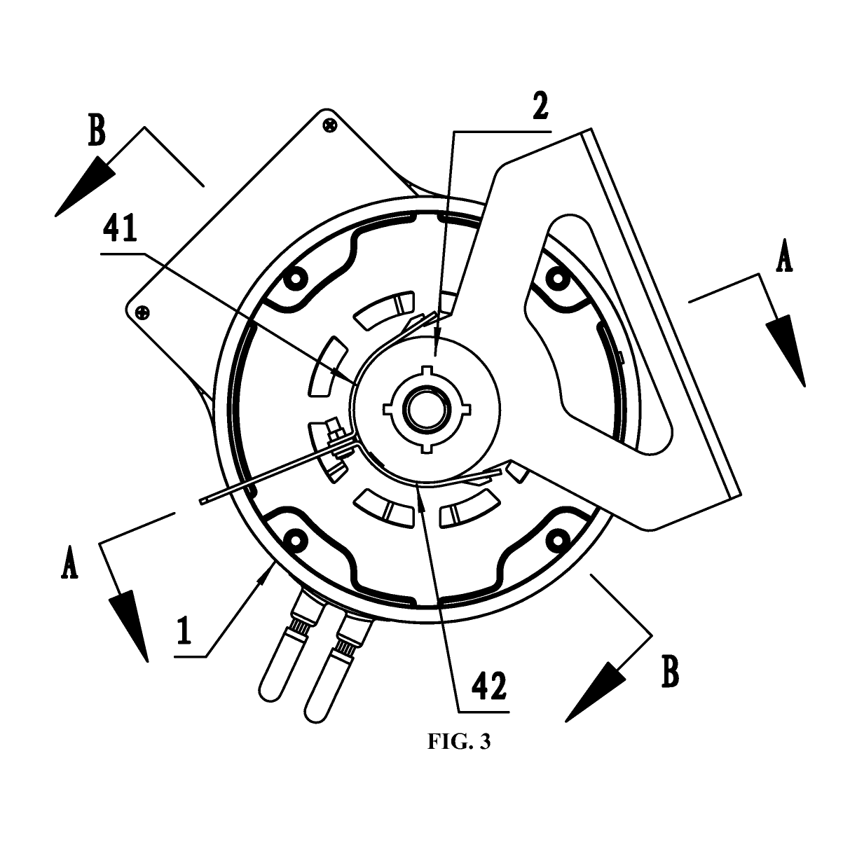

As shown in FIG. 1 and FIG. 3, based on Example 2, the following technical features are added: the locking device 4 comprises: a left clasp 41, and a right clasp 42. Both the two clasps comprise two ends. One end of the left clasp 41 and one end of the right clasp 42 are connected to the supporting plate 31; and the other end of left clasp 41 and the other end of the right clasp 42 are connected together by a screw bolt and a nut for fastening a top of the damping ring 2.

### Example 4

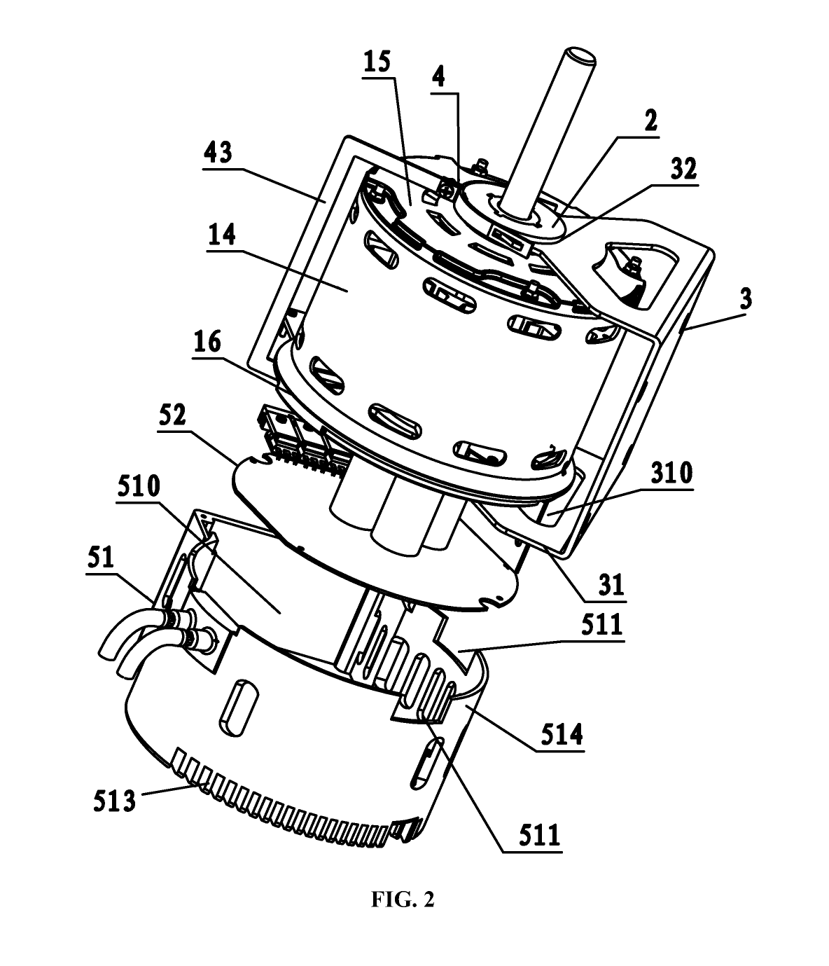

As shown in FIG. 2, based on Example 1, 2 or 3, the following technical features are added: a top of the control box 51 is provided with an opening 510. A plurality of notches 511 is arranged on a top surface of a side wall of the control box 51 outside the opening 510. The notch 511 is embedded into the supporting plate 31. A convex plate 514 is arranged between two adjacent notches 511. A first through hole 310 is disposed on a middle part of the supporting plate 31. The convex plate 514 is embedded in the first through hole 310 and is disposed on the rear end cover 16

### Example 5

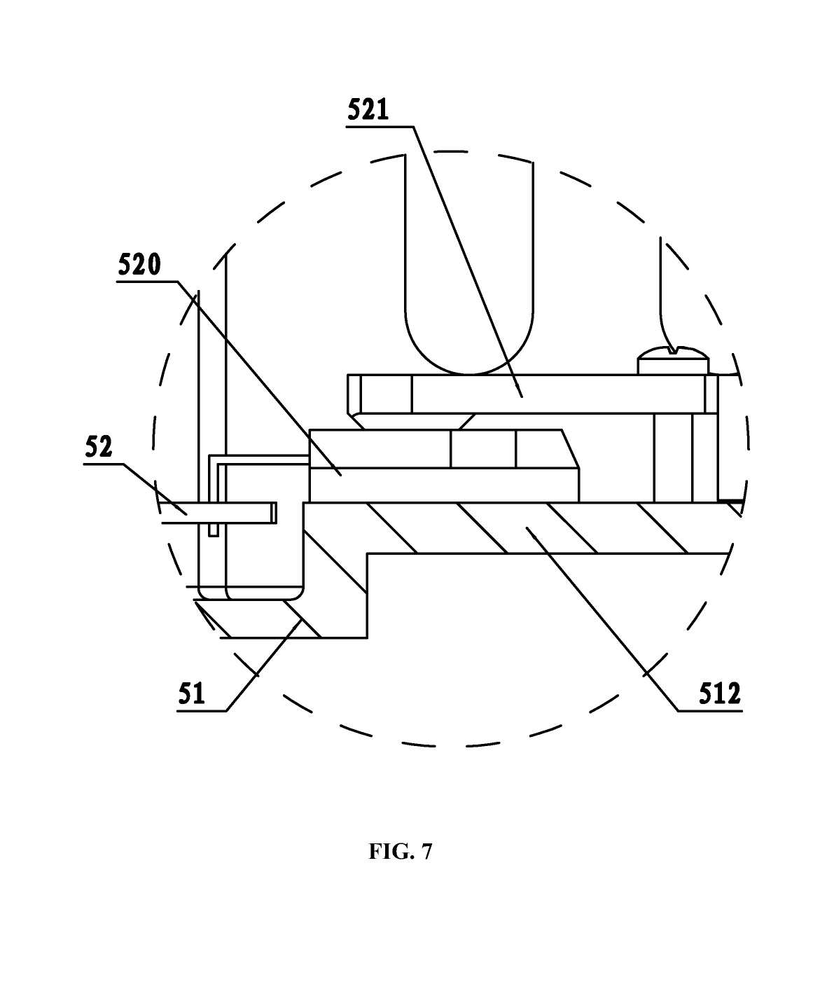

As shown in FIGS. 6 and 7, based on Example 4, the following technical features are added: the circuit board 52 is arranged at a bottom of the control box 51 that is far away from an end comprising the opening 510. An IGBT module 520 is disposed on the circuit board 52. The bottom of the control box 51 is convex to form a heat dissipation boss 512. The IGBT module 520 attaches to a top surface of the heat dissipation boss 512. The IGBT module 520 is pressed by a press plate 521 and fastened on the heat dissipation boss 512 by a screw.

### Example 6

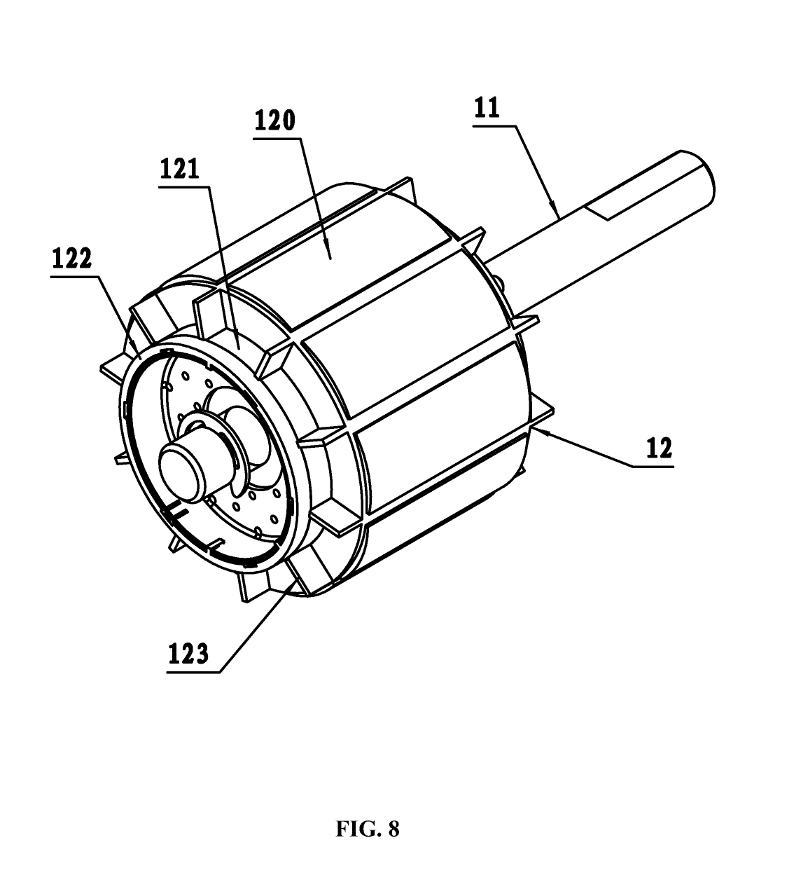

As shown in FIGS. 6 and 8, based on Example 2, the following technical features are added: the rotor assembly 12 comprises: a rotor core 120, a magnetic ring bracket 121, and a magnetic ring 122. The magnetic ring 122 is embedded in the magnetic ring bracket 121. The magnetic ring bracket 121 and the rotor core 120 are integrated as a whole body by injection molding. A plurality of fan blades 123 is disposed outside the magnetic ring 122 on an end surface of the magnetic ring bracket 121.

### Example 7

As shown in FIG. 8, based on Example 6, the following technical feature are added: a plurality of fan blades 123 is evenly distributed on two end surfaces of the magnetic ring bracket 121.

### Example 8

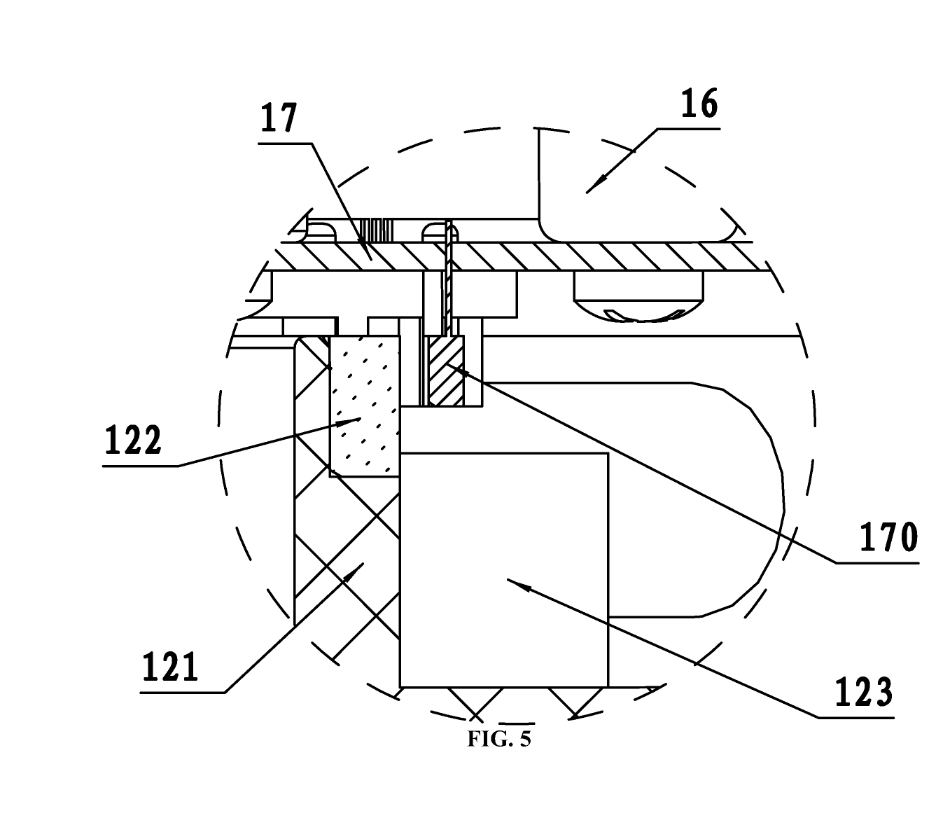

As shown in FIG. 5, based on Example 6, the following technical features are added: a Hall plate 17 is disposed on a bottom of the rear end cover 16 above the magnetic ring bracket 121. A Hall element 170 is arranged on the Hall plate 17 outside the magnetic ring 122.

### Example 9

As shown in FIGS. 1-4, based on Example 3, the following technical features are added: a locking bracket 43 is disposed between the left clasp 41 and the right clasp 42. The locking bracket 43 is connected with the left clasp 41 and the right clasp 42 via the screw bolt and nut and is disposed on the top of the damping ring 2.

### Example 10

As shown in FIGS. 2 and 4, based on Example 1, the following technical features are added: a plurality of heat dissipation ribs 513 is arranged on an outer surface of the control box 51.

### Example 11

As shown in FIGS. 4 and 6, based on Example 2, the following technical features are added: the control box 51 is arranged on the rear end cover 16. The damping ring 2 arranged on the rear end cover 16 is disposed inside the control box 51.

As shown in FIG. 4, an arrow shows a direction of an air flow. The rotor assembly 12 comprises: the rotor core 120, the magnetic ring bracket 121, and the magnetic ring 122. The magnetic ring 122 is embedded in the magnetic ring bracket 121. The magnetic ring bracket 121 and the rotor core 120 are integrated as a whole body by injection molding. A plurality of fan blades 123 is disposed outside the magnetic ring 122 on the end surface of the magnetic ring bracket 121. When the rotor rotates, the air flow enters into the control box 51 through a second through hole 515 arranged on the side wall of the control box 51, and then enters into the motor body 1 through a third through hole 160 arranged on the rear end cover 16, and flows out of the motor through the fourth through hole 140 arranged on the housing 14. Meanwhile, the air flow enters into the motor body 1 through a fifth through hole 150 arranged on the front end cover 15, and flows out of the motor body through the housing through hole 140 arranged on the housing 14.

The controller 5 of the invention is disposed on the motor body 1. The motor is advantageous in a simple and compact structure, small volume, simple and easy installation, and little external interference.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A brushless DC motor, comprising:
a) a motor body (1);
b) a damping ring (2);
c) a mounting bracket (3);
d) a locking device (4); and
e) a controller (5), the controller (5) comprising: a control box (51), and a circuit board (52);
wherein
two sides of the mounting bracket (3) are convex upward to form two supporting plates (31), respectively;
each supporting plate (31) is provided with a recess (32);
the damping ring (2) is disposed on each end of the motor body (1);
a bottom of the damping ring (2) matches with the recess (32) of the mounting bracket (3);
the damping ring (2) is fixed on the mounting bracket (3) by the locking device (4);
the circuit board (52) is arranged inside the control box (51); and
the control box (51) is disposed on the motor body (1).

2. The motor of claim 1, wherein
the motor body (1) comprises: a shaft (11), a rotor assembly (12), a stator assembly (13), a housing (14), a front end cover (15), and a rear end cover (16);
the shaft (11) and the rotor assembly (12) are connected together;
the rotor assembly (12) is nested inside the stator assembly (13);
the housing (14) and the stator assembly (13) are connected together;
the front end cover (15) and the rear end cover (16) are disposed on two ends of the housing (14), respectively;
the shaft (11) is disposed on a bearing of the front end cover (15) and a bearing of the rear end cover (16); and
the control box (51) is disposed on the rear end cover (16).

3. The motor of claim 2, wherein
the locking device (4) comprises: a left clasp (41), and a right clasp (42);
both the two clasps comprise two ends;
one end of the left clasp (41) and one end of the right clasp (42) are connected to the supporting plate (31); and
the other end of left clasp (41) and the other end of the right clasp (42) are connected together by a screw bolt and a nut for fastening a top of the damping ring (2).

4. The motor of claim 1, wherein
a top of the control box (51) is provided with an opening (510);
a plurality of notches (511) is arranged on a top surface of a side wall of the control box (51) outside the opening (510);
the notch (511) is embedded into the supporting plate (31);
a convex plate (514) is arranged between two adjacent notches (511);
a through hole (310) is disposed on a middle part of the supporting plate (31); and
the convex plate (514) is embedded in the through hole (310) and is disposed on the rear end cover (16).

5. The motor of claim 2, wherein
a top of the control box (51) is provided with an opening (510);
a plurality of notches (511) is arranged on a top surface of a side wall of the control box (51) outside the opening (510);
the notch (511) is embedded into the supporting plate (31);
a convex plate (514) is arranged between two adjacent notches (511);
a through hole (310) is disposed on a middle part of the supporting plate (31); and
the convex plate (514) is embedded in the through hole (310) and is disposed on the rear end cover (16).

6. The motor of claim 3, wherein
a top of the control box (51) is provided with an opening (510);
a plurality of notches (511) is arranged on a top surface of a side wall of the control box (51) outside the opening (510);
the notch (511) is embedded into the supporting plate (31);
a convex plate (514) is arranged between two adjacent notches (511);
a through hole (310) is disposed on a middle part of the supporting plate (31); and
the convex plate (514) is embedded in the through hole (310) and is disposed on the rear end cover (16).

7. The motor of claim 4, wherein
the circuit board (52) is arranged at a bottom of the control box (51) far from the opening (510);
an IGBT module (520) is disposed on the circuit board (52);
the bottom of the control box (51) is convex to form a heat dissipation boss (512);
the IGBT module (520) attaches to a top surface of the heat dissipation boss (512); and
the IGBT module (520) is pressed by a press plate (521) and fastened on the heat dissipation boss (512) by a screw.

8. The motor of claim 5, wherein
the circuit board (52) is arranged at a bottom of the control box (51) far from the opening (510);
an IGBT module (520) is disposed on the circuit board (52);
the bottom of the control box (51) is convex to form a heat dissipation boss (512);
the IGBT module (520) attaches to a top surface of the heat dissipation boss (512); and
the IGBT module (520) is pressed by a press plate (521) and fastened on the heat dissipation boss (512) by a screw.

9. The motor of claim 6, wherein
the circuit board (52) is arranged at a bottom of the control box (51) far from the opening (510);
an IGBT module (520) is disposed on the circuit board (52);
the bottom of the control box (51) is convex to form a heat dissipation boss (512);
the IGBT module (520) attaches to a top surface of the heat dissipation boss (512); and
the IGBT module (520) is pressed by a press plate (521) and fastened on the heat dissipation boss (512) by a screw.

10. The motor of claim 2, wherein
the rotor assembly (12) comprises: a rotor core (120), a magnetic ring bracket (121), and a magnetic ring (122);
the magnetic ring (122) is embedded in the magnetic ring bracket (121);
the magnetic ring bracket (121) and the rotor core (120) are integrated as a whole body by injection molding; and
a plurality of fan blades (123) is disposed outside the magnetic ring (122) on an end surface of the magnetic ring bracket (121).

11. The motor of claim 10, wherein the fan blades (123) are evenly distributed on two end surfaces of the magnetic ring bracket (121).

12. The motor of claim 10, wherein a Hall plate (17) is disposed on a bottom of the rear end cover (16) above the magnetic ring bracket (121); and a Hall element (170) is arranged on the Hall plate (17) outside the magnetic ring (122).

13. The motor of claim 3, wherein a locking bracket (43) is disposed between the left clasp (41) and the right clasp (42); and the locking bracket (43) is connected with the left clasp (41) and the right clasp (42) via the screw bolt and nut and is disposed on the top of the damping ring (2).

14. The motor of claim 1, wherein a plurality of heat dissipation ribs (513) is arranged on an outer surface of the control box (51).

15. The motor of claim 2, wherein the control box (51) is arranged on the rear end cover (16); and the damping ring (2) arranged on the rear end cover (16) is disposed inside the control box (51).
